(19) United States
(12) Patent Application Publication
(10) Pub. No.: US 2017/0346932 A1
(43) Pub. Date: Nov. 30, 2017

(54) IN-BAND PATH-TO-PATH SIGNALS USING TCP RETRANSMISSION

(71) Applicant: Cisco Technology, Inc., San Jose, CA (US)

(72) Inventor: Joseph James Hildebrand, Denver, CO (US)

(21) Appl. No.: 15/163,163

(22) Filed: May 24, 2016

(51) Int. Cl. H04L 29/06; H04L 12/733; H04L 29/08

(52) U.S. Cl. CPC H04L 69/22; H04L 69/163; H04L 67/02; H04L 45/20; H04L 63/0428; H04L 63/06

(57) ABSTRACT

In one embodiment, a side source device receives an original packet on a transmission control protocol (TCP) connection from an original source device to an original destination device, the original packet having original data and one or more forwarding properties specific to the original packet, and forwards the original packet from the side source device on a path toward the original destination device. The side source device also generates a side packet with side data different from the original data, the side packet having the same one or more forwarding properties specific to the original packet, and forwards the side packet on the path toward the original destination device, the side packet intended for reception and processing of the side data by a side destination device that is on the path toward the original destination device. In another embodiment, the side destination device receives, processes, and drops the side packet.

### TECHNICAL FIELD

The present disclosure relates generally to computer networks, and, more particularly, to in-band path-to-path signals using transmission control protocol (TCP) retransmission.

### BACKGROUND

Network operators often want to be able to send extra data along a particular packet flow, such as a transmission control protocol (TCP) flow (e.g., to describe the TCP flow). For example, one way this has been completed in the past is to inject hyper-text transmission protocol (HTTP) headers into every plaintext HTTP request transiting parts of the network. However, with the rise of encryption on the Internet, such techniques are either incomplete or inoperable, and as such, operators are looking for other mechanisms to send data to their partners further along the network path.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example network device;

FIG. 3 illustrates an example of in-band path-to-path signals using transmission control protocol (TCP) retransmission;

FIG. 4 illustrates an example of an original packet and a side packet for in-band path-to-path signals using TCP retransmission;

FIG. 5 illustrates an example packet exchange for in-band path-to-path signals using TCP retransmission;

FIGS. 6A-6B illustrate example packet exchanges for protecting against packet errors at an original destination device for in-band path-to-path signals using TCP retransmission;

FIGS. 7A-7B illustrate example packet exchanges for use with larger side data for in-band path-to-path signals using TCP retransmission;

FIG. 8 illustrates an example of bi-directional in-band path-to-path signals using TCP retransmission;

FIG. 9 illustrates an example simplified procedure for in-band path-to-path signals using TCP retransmission, particularly from the perspective of a side source device; and

FIG. 10 illustrates an example simplified procedure for in-band path-to-path signals using TCP retransmission, particularly from the perspective of a side destination device.

### DESCRIPTION OF EXAMPLE EMBODIMENTS

### Overview

According to one or more embodiments of the disclosure, a side source device in a computer network receives an original packet on a transmission control protocol (TCP) connection from an original source device to an original destination device, the original packet having original data and one or more forwarding properties specific to the original packet, and forwards the original packet from the side source device on a path toward the original destination device. The side source device also generates a side packet with side data different from the original data, the side packet having the same one or more forwarding properties specific to the original packet, and forwards the side packet on the path toward the original destination device, the side packet intended for reception and processing of the side data by a side destination device that is on the path toward the original destination device.

According to one or more additional embodiments of the disclosure, a side destination device in a computer network receives an original packet on a TCP connection from an original source device to an original destination device, the original packet having original data and one or more forwarding properties specific to the original packet, and forwards the original packet on a path toward the original destination device. The side destination device then also receives a side data packet with side data different from the original data, the side packet having the same one or more forwarding properties specific to the original packet, processes the side data, and, drops the side data packet, accordingly.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. Data packets (e.g., traffic and/or messages sent between the devices) may be exchanged among the devices of a computer network using predefined network communication protocols, such as the Internet Protocol (IP), Transmission Control Protocol (TCP), TCP/IP, and other known protocols where appropriate. In this context, a protocol consists of a set of rules defining how the nodes interact with each other.

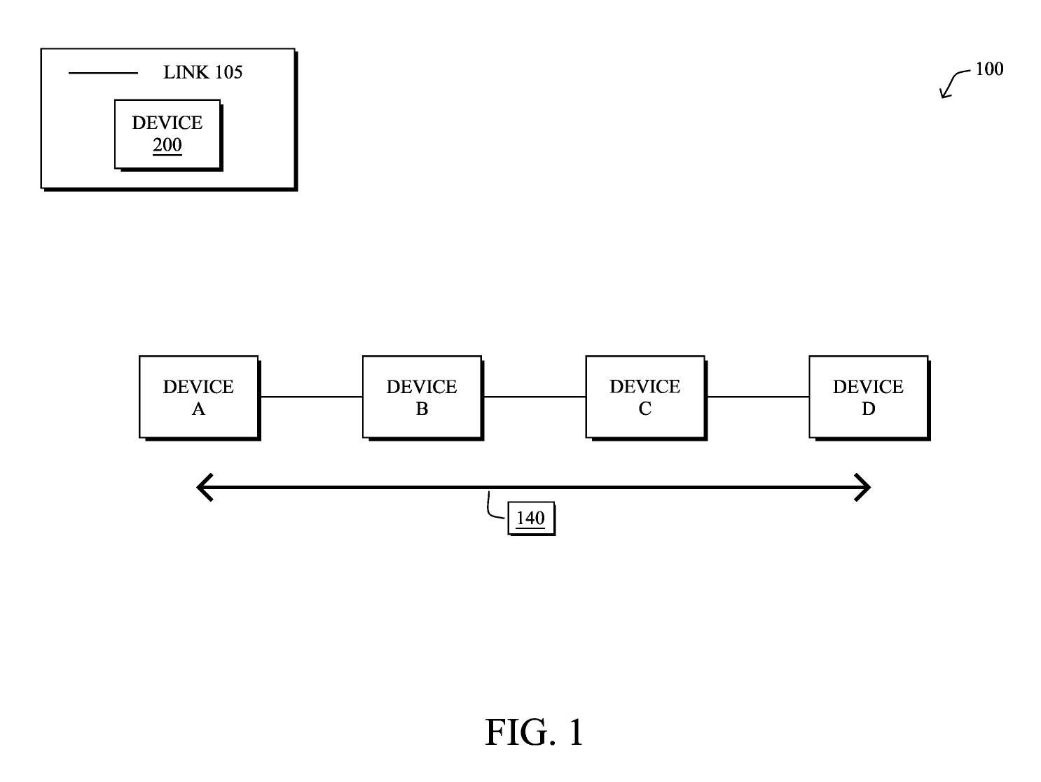

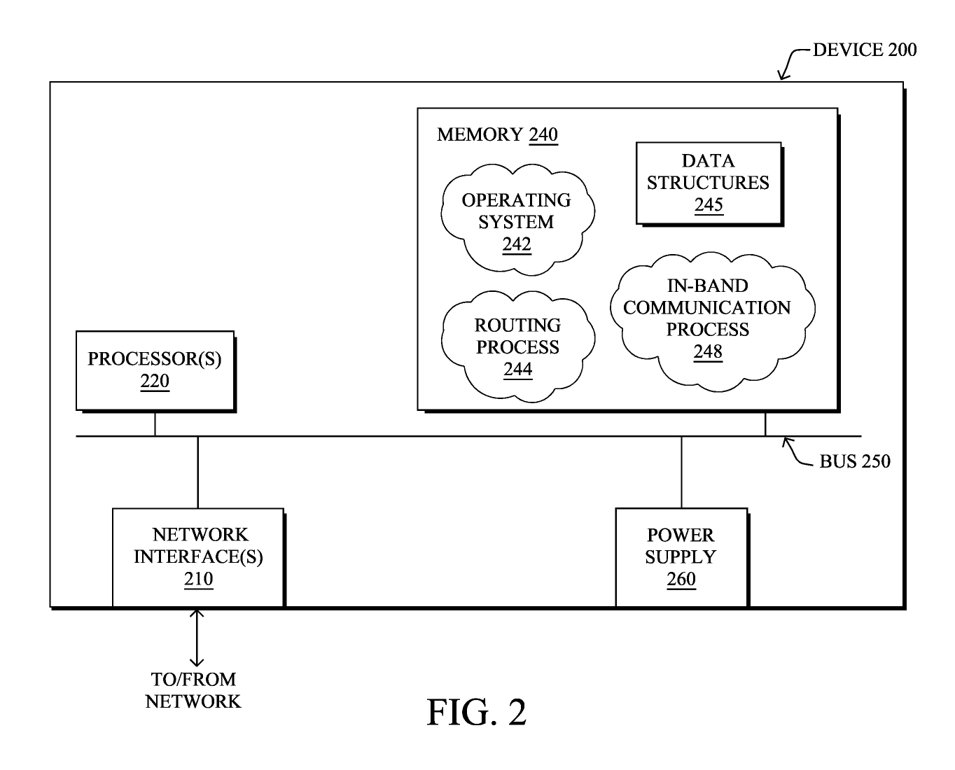

FIG. 1 is a schematic block diagram of an example simplified computer network 100 illustratively comprising devices 200 (e.g., described in FIG. 2 below) interconnected by various methods of communication. For instance, the links 105 may be wired links or shared media (e.g., wireless links) where certain device 200, such as, e.g., routers, switches, computers, servers, network appliances, etc., may be in communication with other devices 200, e.g., based on physical connectivity, topology selection, etc., as will be understood in the art. Illustratively, for the purposes of discussion below, the devices 200 define a path the consists of device “A”, device “B”, device “C”, and device “D”, where sending a data packet 140 from device A (e.g., a source) to device D (e.g., a destination) comprises traversing one or more intermediate devices, namely devices B and C, respectively. As a non-limiting example, devices A and D may be end devices (e.g., user devices, servers, etc.), and devices B and C may be intermediate network devices (e.g., routers, switches, firewalls, etc.). Those skilled in the art will understand that any number of devices, links, etc. may be used in the computer network, and that links may represent one or more additional intermediate devices that aren't explicitly shown, and thus that the view shown herein is for simplicity.

FIG. 2 is a schematic block diagram of an example device 200 that may be used with one or more embodiments described herein, e.g., as any of the devices shown in FIG. 1 above, but particularly intermediate devices (e.g., device B and device C). The device may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for power-line communication (PLC) the network interface 210 may communicate through the power supply 260, or may be an integral component of the power supply.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise routing process/services 244, and an illustrative “in-band communication” process 248, as described herein. Note that while in-band communication process 248 is shown in centralized memory 240, alternative embodiments provide for the process to be specifically operated within the network interfaces 210.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Notably, routing process (services) 244 contains computer executable instructions executed by the processor 220 to perform functions provided by one or more routing protocols, such as various interior gateway protocols (IGPs) and/or border gateway protocols (BGPs). These functions may, on capable devices, be configured to manage a routing/forwarding table (a data structure 245) containing, e.g., data used to make routing/forwarding decisions.

As noted above, network operators often want to be able to send extra data along a particular packet flow, such as a TCP flow (e.g., to describe the TCP flow). With the rise of encryption on the Internet, however, current techniques are either incomplete or inoperable, and as such, operators are looking for other mechanisms to send data to their partners further along the network path.

The techniques herein, therefore, provide in-band path-to-path signals using TCP retransmission, where a TCP retransmit containing different data than the original packet can signal other network elements on the path, without the destination endpoint detecting the added data, even for encrypted connections. Such “side-channel” communication can be used for things such as in-band route tracing by network elements (e.g., to ensure that traffic flows over predicted routes), feature negotiation on a per-flow basis by networks (e.g., used to route or shape traffic differently based on subscriber billing status), tagging geographic information of the server side to allow policy manipulation, and so on.

Specifically, according to one or more embodiments of the disclosure as described in detail below, a “side source” device (sourcing the side-channel data, e.g., device B) receives an original packet on a TCP connection from an original source device (e.g., device A) to an original destination device (e.g., device D), the original packet having original data and one or more forwarding properties specific to the original packet. The side source device forwards the original packet from the side source device on a path toward the original destination device, and generates a side packet with side data different from the original data, the side packet having the same one or more forwarding properties specific to the original packet. This side packet is then forwarded on the path toward the original destination device, where the side packet is intended for reception and processing of the side data by a “side destination” device (e.g., device C) that is on the path toward the original destination device. Note that the use of the term “side” is not meant to limit the scope of the embodiments herein, and is simply used to describe a source and destination of the “side-channel” (e.g., piggybacked, in-band, covert, etc.) data that is different from the originating source and destination device of the TCP connection.

Illustratively, the techniques described herein may be performed by hardware, software, and/or firmware, such as in accordance with the “in-band communication” process 248, which may contain computer executable instructions executed by the processor 220 (or independent processor of interfaces 210) to perform functions relating to the techniques described herein, e.g., in conjunction with routing process 244 (and/or other process that is desirous of using the side channel for communication).

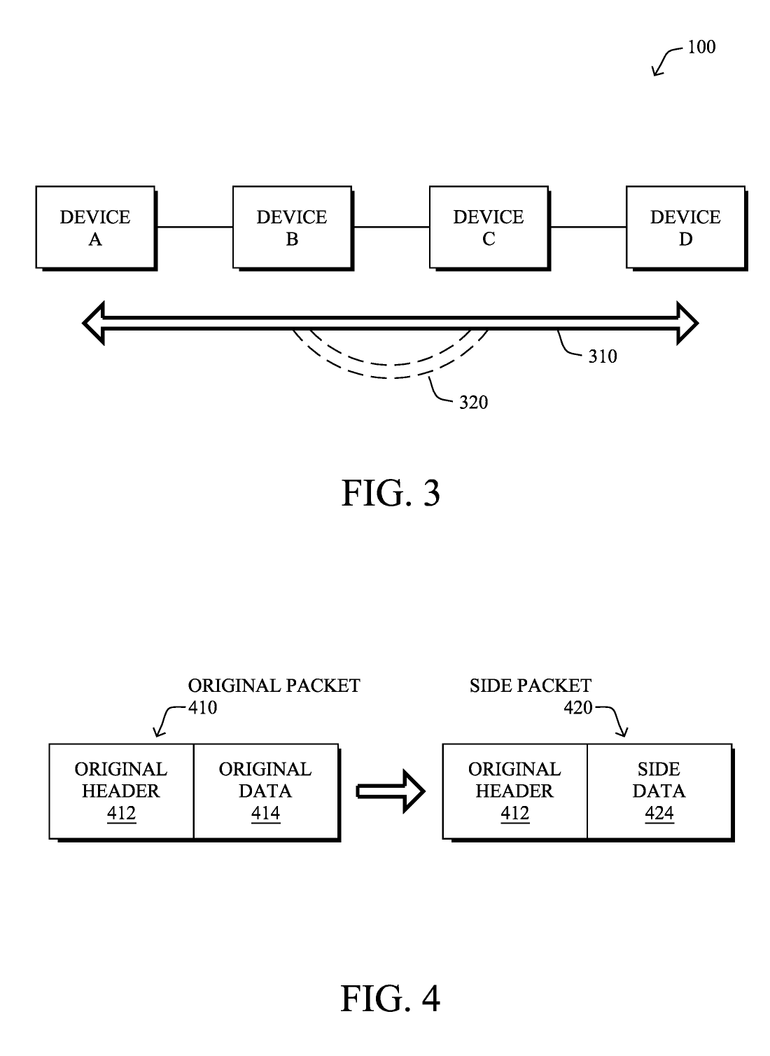

FIG. 3 illustrates an example of in-band path-to-path signals using TCP retransmission in accordance with one or more of the embodiments herein. Operationally, once an original source device A opens a TCP connection 310 to an original destination device D (e.g., using a conventional TCP 3-way handshake and (potentially) an encryption protocol such as a session-based encryption protocol (e.g., transport layer security or “TLS”)), the end devices A and D start exchanging information (data packets 140) over that connection. Intermediate device B is a network element between device A and D, and has access to the original packet traffic on the TCP connection 310. Assuming that device B wants to send information to another intermediate device C closer to the original destination device D along the path of the TCP connection 310 (or even to a modified networking stack at the original destination device D), such as information about the original source device A or otherwise, device B may begin to source such “side-channel” information along an in-band channel 320 that uses the original TCP connection as its basis (from device B as a “side source device” to device C (or D) as a “side destination device” herein).

In particular, in accordance with the techniques described herein, when intermediate device B (the side source device) sees a data packet 140 on the connection 310, it forwards that original packet along, and then sends another TCP packet with the exact same forwarding properties that were contained within the original packet (e.g., size, sequence number, flags, etc.), but now with different data. This new “side packet” data contains the added information, which is hereafter called the “side channel” data or simply “side data”.

FIG. 4 illustrates an example of an original packet 410 and a side packet 420 for in-band path-to-path signals using TCP retransmission. Specifically, the simplified original data packet 410 has an original header 412 and original data 414. The original header, in particular, is defined based on the particular transmission protocol, and may contain one or more forwarding properties that are specific to the original packet 410. For example, such properties may include a source address, a destination address, a source port, a destination port, a packet size (which should thus also be the size of the side packet 420), a sequence number, one or more flags, and one or more differentiated services code point (DSCP) properties. The side packet 420 may thus be generated such that it has the same original header 412 and associated forwarding properties that are specific to the original packet 410, but has the new side data 424 as desired. Since the side-channel data 424 is placed within a packet 420 that uses the same header information as the original packet 410 (e.g., the same 5-tuple (source and destination addresses and ports and protocol) and DSCP markings as the original packet), it should follow a network path similar to the original packet (i.e., of TCP connection 310), at least until the side destination device is reached along the in-band path 320.

Note that in one or more embodiments, the side data 424 may be encrypted, such as based on TLS encryption (e.g., aligning TLS handshakes between the side source device B and the side destination device C in the same order as the original source and destination devices A and D are using to negotiate their end-to-end TLS), or else previously agreed-upon keying information between the side source device and side destination device (e.g., where the side source and side destination devices B and C are administrated by the same entity, appearing to eavesdroppers between B and C as a simple garbled packet). In still another embodiment, the encrypting of side data 424 may be based on applying steganography to place the side data within the original data. That is, the side source device B could use steganography to encode its data in smaller errors in the original packet data 414 in order to make the side data more difficult to detect. (Note that this approach may take much longer to transmit the same amount of data, potentially requiring multiple packet transmissions, as described below.)

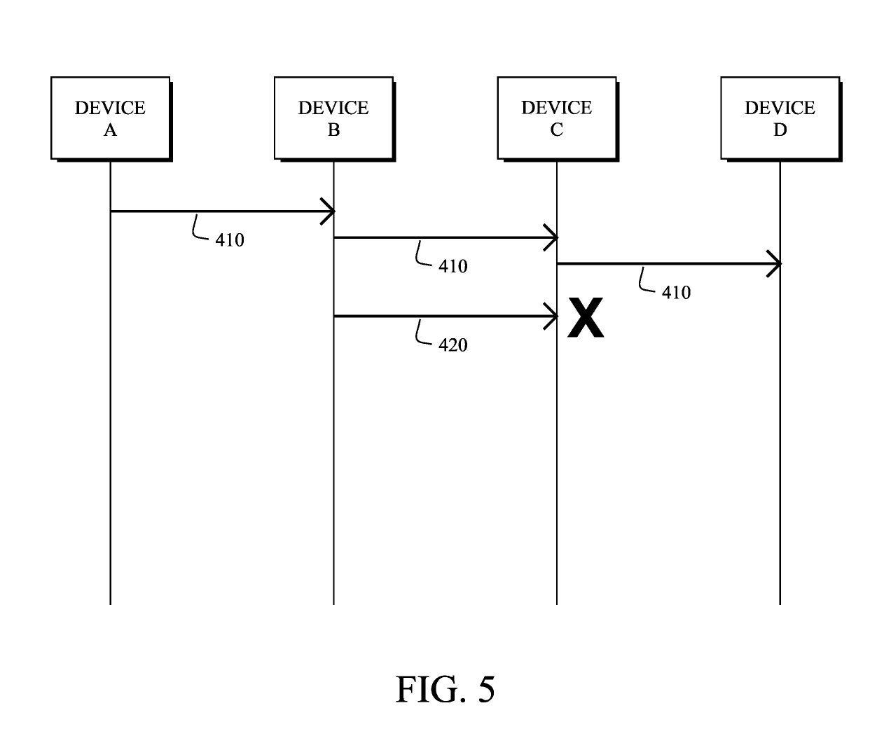

FIG. 5 illustrates an example packet exchange for in-band path-to-path signals using TCP retransmission, where the first (legitimate) copy of the packet 410 is delivered to the application on the destination device D (or is kept in a TCP buffer at the destination device D). The second packet transmitted, however, is the side packet 420, which contains the information that side source device B intends for consumption by side destination device C, where the side destination device C is configured to drop the side packet to thus not forward it on to the original destination device D.

The side destination device C may be configured to detect and inspect the side packet 420 based on seeing the duplicate packet (based on the shared header 412, sequence number, etc.) and checking the data 424 for a further indication, or other manners of detection, such as where the header 412 of the side packet 420 contains some indication that it is a side packet that does not otherwise affect the transmission of the packet in a manner that is different than the original packet.

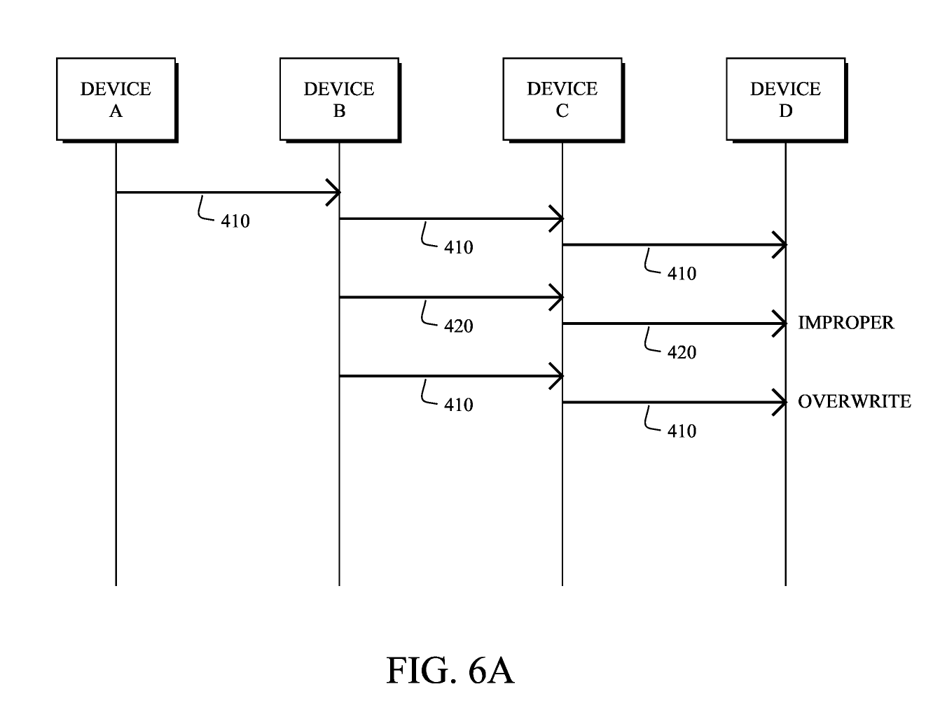

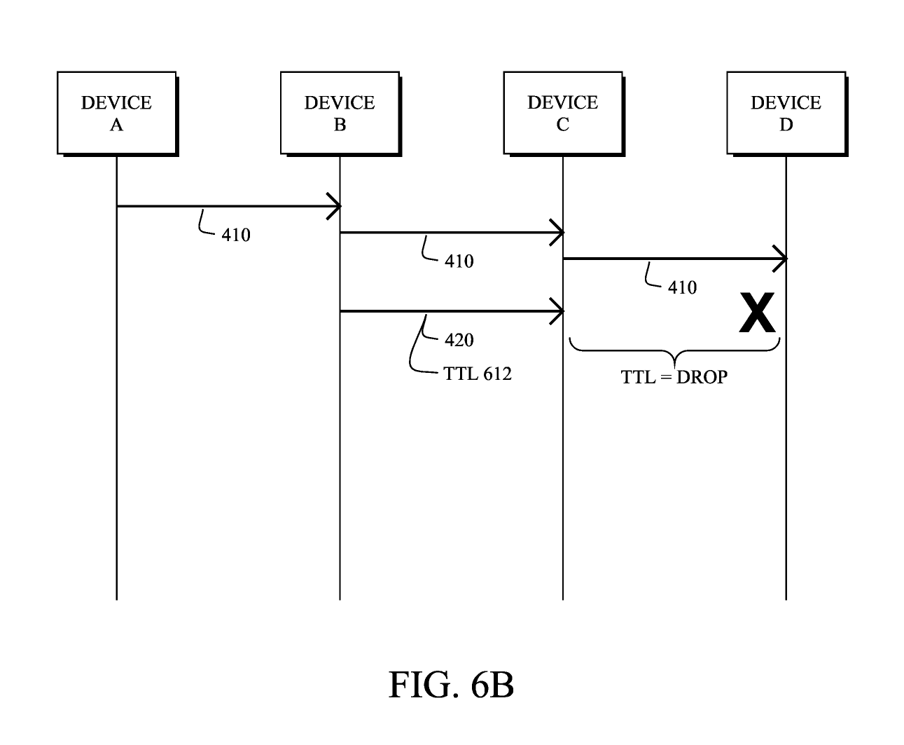

There may be instances, however, when the intended side destination device C is either misconfigured to forward the side packet 420 to Bob, or else a different path is taken that bypasses the side destination device. FIGS. 6A-6B thus illustrate example packet exchanges for protecting against packet errors at an original destination device for in-band path-to-path signals using TCP retransmission. In particular, in FIG. 6A, the side source device B may send a third packet toward the original destination device D, which is a copy of the original (legitimate) packet 410. By re-forwarding the original packet from the side source device on the path toward the original destination device after forwarding the side packet in this manner, the re-forwarded original packet will overwrite the side data information that may be stored still within the TCP buffer of the original destination device D. Note that, if the original data has already been delivered out of the TCP buffer at the original destination device D before the side-data was accidentally received, this duplicate packet (based on the forwarding properties that are specific to the original packet 410) will be dropped by the original destination device D without comment. (Note still that there is a small chance that the original destination device D would get the side-channel data delivered to it in certain timings, which is why it is important to try to drop side channel packets 420 at the side destination device C.)

As a refinement, as shown in FIG. 6B, if the side source device B knows the number of network hops between itself and the side destination device C (or perhaps and the original destination device D), then the side source device B can set the IP time-to-live (TTL) counter 612 to a value on the side-channel packets 420 to ensure that the original destination device D will not receive them but the side destination device C will (that is, a TTL that is less than a number of hops to reach the original destination device D and equal to or greater than a number of hops to reach the side destination device C).

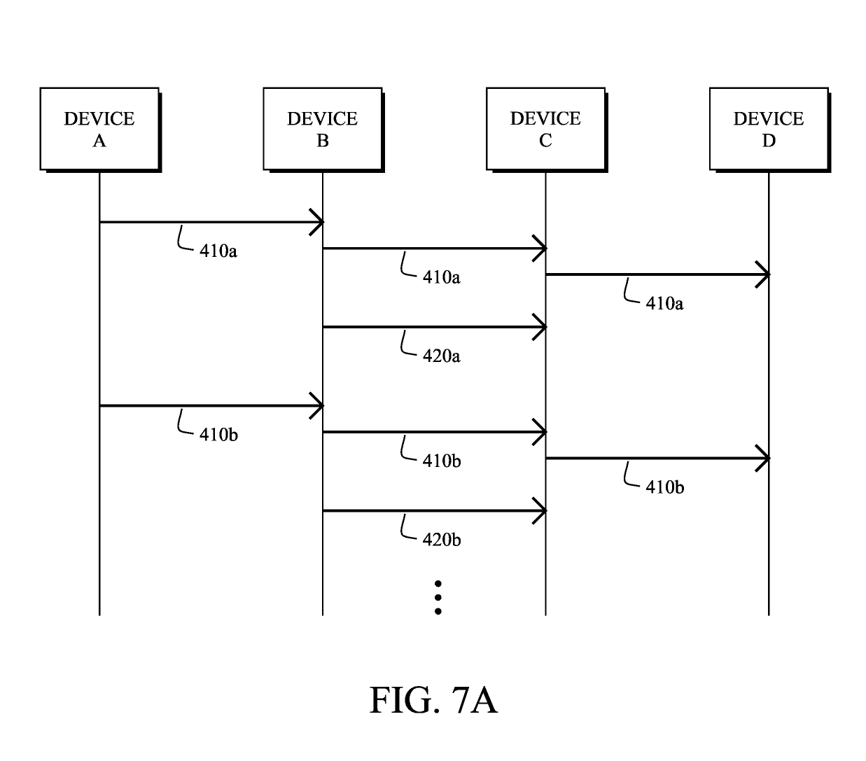

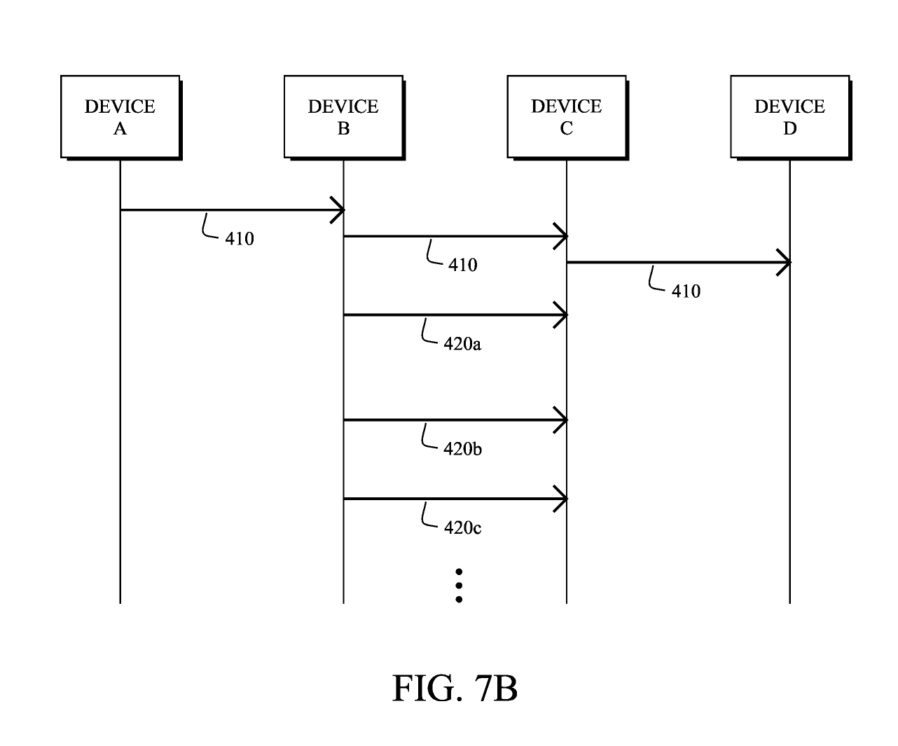

Notably, the side source device B may need to send more side than can be sent in a single side packet 420. As such, FIGS. 7A-7B illustrate example packet exchanges for use with larger side data for in-band path-to-path signals using TCP retransmission. For instance, as shown in FIG. 7A, the side source device B can continue to perform this mechanism until enough legitimate packets have passed by to allow for its desired data size has been reached in the side channel. That is, for each of a plurality of original packets received by the side source device (410a, 410b, etc.), where each of the plurality of original packets have its own original data and specific forwarding properties (e.g., incremental sequence numbers), the side source device may forward those on, and generate and forward a plurality of corresponding side packets (420a, 420b, etc.) with the side data (i.e., the plurality of side packets each having the specific forwarding properties of a corresponding original packet).

Conversely, as shown in FIG. 7B, the side source device B may pretend to retransmit the same sequence number multiple times to send larger payloads, generating and forwarding a plurality of side packets (420a, 420b, etc.) with the side data that each have the same specific forwarding properties of the one original packet 410. (It is important to have both approaches available, as certain networks may classify the scenario in FIG. 7B as a denial of service or “DoS” attack, where a large quantity of packets are sent that have similar signatures in an attempt to disrupt network service.)

Notably, in either of FIG. 7A or FIG. 7B, the same protection techniques of FIGS. 6A and 6B may be used, and the example packet exchanges shown herein are not meant to be exclusive of one another.

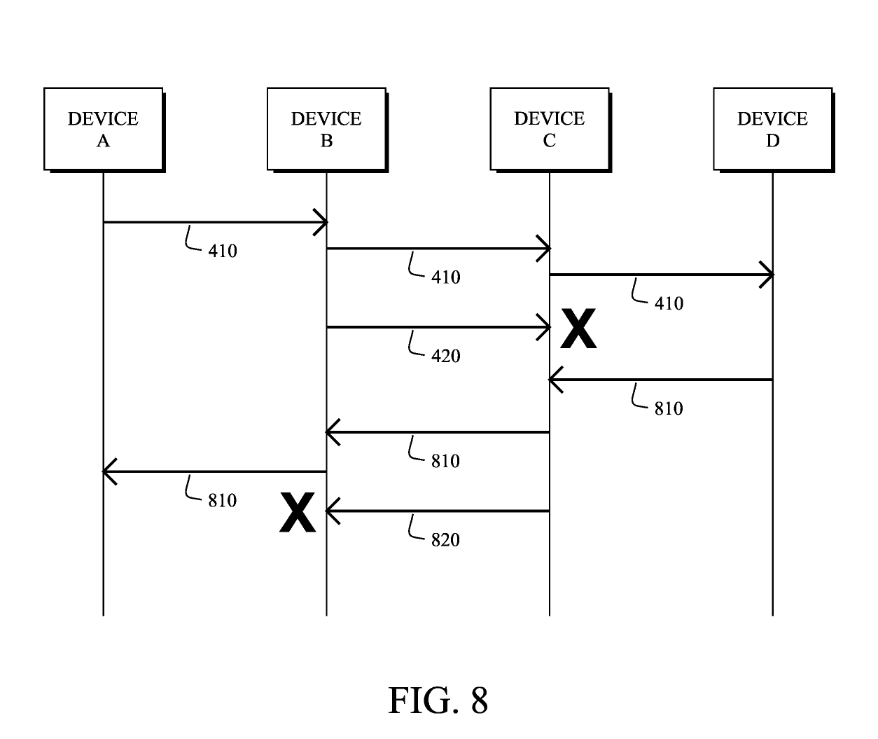

Moreover, the techniques shown herein may be bi-directional. For instance, as shown in FIG. 8, an example of bi-directional in-band path-to-path signals using TCP retransmission is illustrated where a return original packet 810 (from original destination device D to original source device A) may be used in a similar manner to allow for a return side packet 820 to be sent from the side destination device C back to the side source device B according to any of the techniques described above.

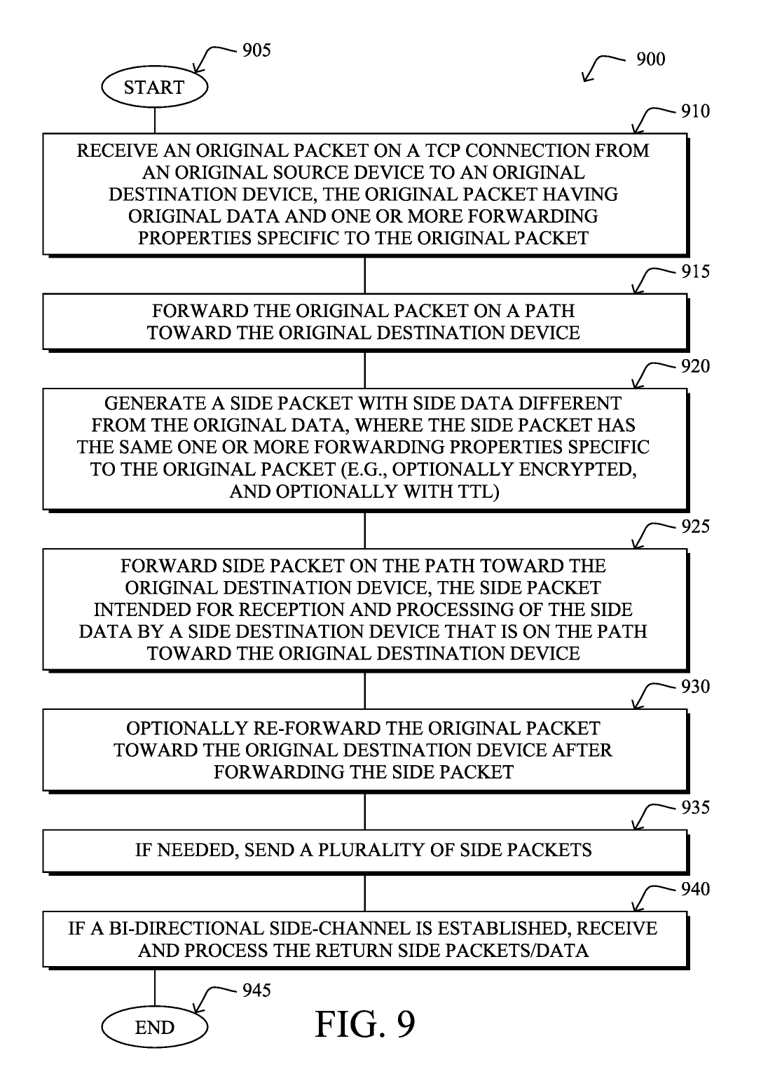

FIG. 9 illustrates an example simplified procedure 900 for in-band path-to-path signals using TCP retransmission in a computer network in accordance with one or more embodiments described herein, particularly from the perspective of a side source device. The procedure 900 may start at step 905, and continues to step 910, where, as described in greater detail above, a side source device B in a computer network receives an original packet 410 on a TCP connection 310 from an original source device A to an original destination device D, the original packet having original data 414 and one or more forwarding properties specific to the original packet (e.g., header 412). In step 915, the original packet is forwarded from the side source device B on a path toward the original destination device D.

As detailed above, in step 920, the side source device generates a side packet 420 with side data 424 different from the original data, where the side packet has the same one or more forwarding properties specific to the original packet (e.g., header 412). Note that in step 920, the side data may also be encrypted, as mentioned above. In step 925, the side packet 420 may then be forwarded from the side source device B on the path toward the original destination device D (side channel 320), the side packet intended for reception and processing of the side data by a side destination device C that is on the path toward the original destination device D. Notably, to account for accidental delivery of the side packet 420 to the original destination device D, in step 930 the side source device B may optionally re-forward the original packet 410 toward the original destination device after forwarding the side packet, or else may have optionally set an appropriate TTL counter within the side packet in step 920.

If any additional side packets 420 are required to send the side data 424, then in step 935 the side source device B may send a plurality of side packets 420 in a manner as described above (in FIGS. 7A-7B). Further, if a bi-directional side-channel is established (i.e., where the side destination device is configured to return side data to the side source device), then in step 940 the side source device B may also receive and process the return side packets/data as described herein (e.g., in accordance with a side destination device procedure as described below).

The illustrative procedure 900 ends in step 945, notably with the option to receive additional original packets and send additional side packets, accordingly. Note also that while it is not explicitly shown, if the side source device B does not desire to send any side data, it may simply forward the original packets on without further processing. (In other words, the techniques herein need only occur when there is side data to be sent.)

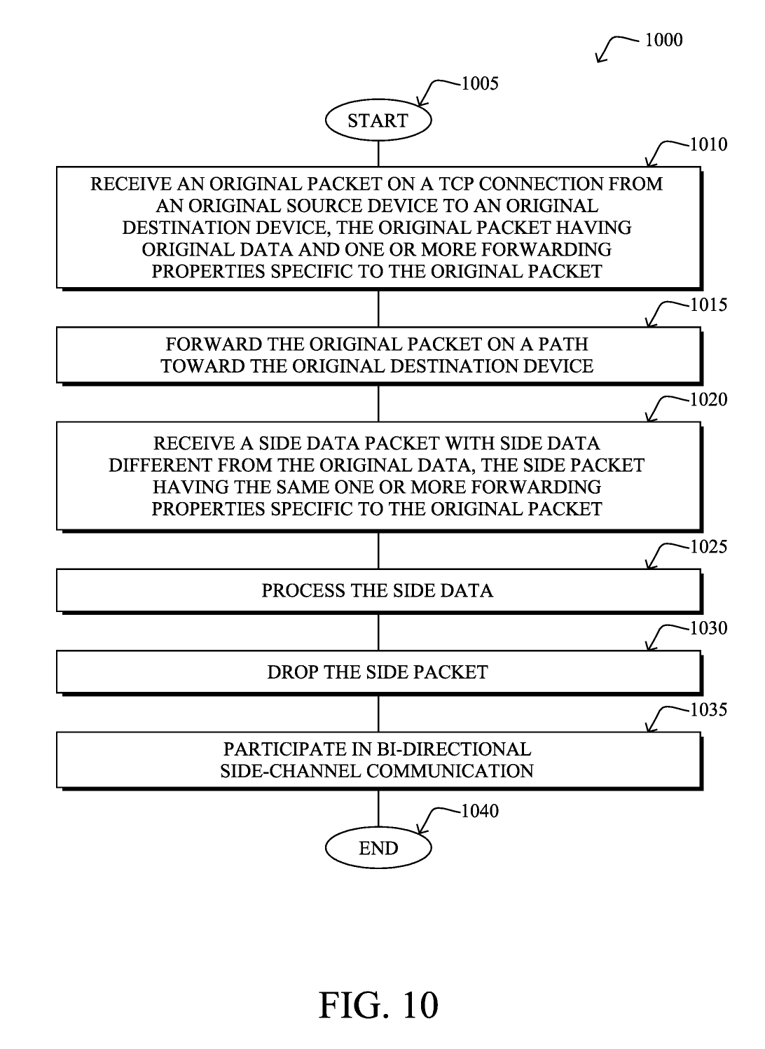

Additionally, FIG. 10 illustrates an example simplified procedure for in-band path-to-path signals using TCP retransmission in a computer network in accordance with one or more embodiments described herein, particularly from the perspective of a side destination device. The procedure 1000 may start at step 1005, and continues to step 1010, where, as described in greater detail above, a side destination device C in a computer network receives an original packet 410 on a TCP connection 310 from an original source device A to an original destination device D, the original packet having original data 414 and one or more forwarding properties specific to the original packet (e.g., header 412). In step 1015, the side destination device C forwards the original packet 410 on a path toward the original destination device D. In addition, in step 1020, the side destination device C may also receive a side data packet 420 with side data 424 different from the original data 414, the side packet having the same one or more forwarding properties specific to the original packet (e.g., the same header 412).

In step 1025, the side destination device C may process the side data, which, as mentioned above, may be based on detecting the “duplicate” packet or other mechanisms for distinguishing the side packet 420 from an original packet 410. In step 1030, the side destination device C should then drop the side packet 420 accordingly. Note that steps 1020-1030 may recur repeatedly if a plurality of side packets are sent as described above. Also, in step 1035, the side destination device C may participate in bi-directional side-channel communication, such as by acting generally as a side source device as described above, but instead using return original packets 810 and generating return side packets 820, accordingly.

The illustrative procedure 1000 ends in step 1040, notably with the option to receive additional original packets and additional side packets, accordingly.

It should be noted that while certain steps within procedures 900-1000 may be optional as described above, the steps shown in FIGS. 9-10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 900-1000 are described separately, certain steps from each procedure may be incorporated into each other procedure, and the procedures are not meant to be mutually exclusive.

The techniques described herein, therefore, provide for in-band path-to-path signals using TCP retransmission in a computer network. In particular, the techniques herein require minimal state at the side source device, since the sequence numbers are never modified. Also, this approach will work for the most tightly-encrypted application-layer protocols, even those that were able to somehow include TCP information in their protection approach, and should work through many different types of intermediate devices (except, perhaps, for devices that terminate and re-generate new TCP flows). Further, large amounts of data can potentially be sent in a relatively covert manner, and no other socket needs to be created, so there is no need to further describe the flow on the other side.

It is important to note that in accordance with one or more embodiments of the techniques herein, one illustrative intent of the side packet is that it will either not reach the original destination (e.g., setting the IP TTL of the side packet to a low value or else having the side destination not forward the side packet), or it will be ignored by the original destination (e.g., through the management of the sequence numbers, etc.), as described above.

While there have been shown and described illustrative embodiments that provide for in-band path-to-path signals using TCP retransmission in a computer network, it is to be understood that various other adaptations and modifications may be made within the spirit and scope of the embodiments herein. For example, the embodiments have been shown and described herein with relation to TCP connections, specifically. However, it should be noted that the embodiments in their broader sense are not limited to any particular transmission control protocol, and may, in fact, be used with any suitable transmission control protocol. In addition, while a certain processing order has been generally described, such as sending a side packet after each original packet, other suitable orders may be used, such as sending a side packet with re-used forwarding properties from a previous original packet that need not be the immediately previous original packet.

Moreover, while certain techniques have been shown above for differentiating the side packets/traffic from the original packet, other techniques are also specifically contemplated herein. For example, specific numbers (e.g., “magic numbers” or other distinctive unique values) may be placed within the content (e.g., of the side data) to differentiate the side traffic. Alternatively, specific sequence number patterns may be used to differentiate side traffic, such as, e.g., one of a fixed set that is not currently within the transmission window. Still other techniques may be used, such as specific set bits that do not affect the one or more forwarding properties specific to the original packet (e.g., “evil bits” as described in RFC 3514) or other explicit differentiators of the side traffic that may be appreciated by those skilled in the art.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a side source device in a computer network, an original packet on a transmission control protocol (TCP) connection from an original source device to an original destination device, the original packet having original data and one or more forwarding properties specific to the original packet;
forwarding the original packet from the side source device on a path toward the original destination device;
generating, by the side source device, a side packet with side data different from the original data, the side packet having the same one or more forwarding properties specific to the original packet; and
forwarding the side packet from the side source device on the path toward the original destination device, the side packet intended for reception and processing of the side data by a side destination device that is on the path toward the original destination device.

2. The method as in claim 1, further comprising:
re-forwarding the original packet from the side source device on the path toward the original destination device after forwarding the side packet.

3. The method as in claim 1, wherein the side data requires a plurality of side packets, the method further comprising:
generating, by the side source device, a plurality of side packets with the side data, the plurality of side packets having the same one or more forwarding properties specific to the original packet; and
forwarding the plurality of side packets from the side source device on the path toward the original destination device, the plurality of side packets intended for reception and processing of the side data by the side destination device that is on the path toward the destination device.

4. The method as in claim 1, wherein the side data requires a plurality of side packets, the method further comprising:
receiving, at the side source device, a plurality of original packets on the TCP connection from the original source device to the original destination device, the plurality of original packets each having original data and one or more forwarding properties specific to each original packet of the plurality of original packets;
forwarding the plurality of original packets from the side source device on the path toward the original destination device;
generating, by the side source device, a plurality of side packets with the side data, the plurality of side packets each having one or more forwarding properties specific to a corresponding original packet of the plurality of original packets; and
forwarding the plurality of side packets from the side source device on the path toward the original destination device, the plurality of side packets intended for reception and processing of the side data by the side destination device that is on the path toward the destination device.

5. The method as in claim 1, further comprising:
setting, by the side source device, a time-to-live (TTL) counter within the side packet that is less than a number of hops to reach the original destination device and equal to or greater than a number of hops to reach the side destination device.

6. The method as in claim 1, wherein the side destination device is configured to return side data to the side source device, the method further comprising:
receiving, at the side source device, a return original packet on the TCP connection from the original destination device to the original source device, the return original packet having return original data and one or more forwarding properties specific to the return original packet;
forwarding the return original packet from the side source device on a return path toward the original source device;
receiving, at the side source device, a return side data packet with return side data different from the return original data, the return side packet having the same one or more forwarding properties specific to the return original packet;
processing, by the side source device, the return side data; and
dropping the return side data packet by the side source device.

7. The method as in claim 1, further comprising:
encrypting the side data.

8. The method as in claim 7, wherein the encrypting is based on at least one of either session-based encryption or agreed-upon keying information between the side source device and side destination device.

9. The method as in claim 7, wherein the encrypting is based on applying steganography to place the side data within the original data.

10. The method as in claim 1, further comprising:
differentiating the side packet from the original packet based on one or more explicit differentiators selected from a group consisting of: specific numbers placed within the side data; specific sequence number patterns; and specific set bits that do not affect the one or more forwarding properties specific to the original packet.

11. The method as in claim 1, wherein the one or more forwarding properties specific to the original packet are selected from a group consisting of: a source address; a destination address; a source port; a destination port; a packet size; a sequence number; one or more flags; and one or more differentiated services code point (DSCP) properties.

12. An apparatus, comprising:
one or more network interfaces to communicate as an intermediate side source device between an original source device and an original destination device;
a processor coupled to the network interfaces and adapted to execute one or more processes; and
a memory configured to store a process executable by the processor, the process when executed operable to:
receive an original packet on a transmission control protocol (TCP) connection from the original source device to the original destination device, the original packet having original data and one or more forwarding properties specific to the original packet;
forward the original packet on a path toward the original destination device;
generate a side packet with side data different from the original data, the side packet having the same one or more forwarding properties specific to the original packet; and
forward the side packet on the path toward the original destination device, the side packet intended for reception and processing of the side data by a side destination device that is on the path toward the original destination device.

13. The apparatus as in claim 12, wherein the process when executed is further operable to:
re-forward the original packet on the path toward the original destination device after forwarding the side packet.

14. The apparatus as in claim 12, wherein the side data requires a plurality of side packets, wherein the process when executed is further operable to:
generate a plurality of side packets with the side data, the plurality of side packets having the same one or more forwarding properties specific to the original packet; and
forward the plurality of side packets on the path toward the original destination device, the plurality of side packets intended for reception and processing of the side data by the side destination device that is on the path toward the destination device.

15. The apparatus as in claim 12, wherein the side data requires a plurality of side packets, wherein the process when executed is further operable to:
receive a plurality of original packets on the TCP connection from the original source device to the original destination device, the plurality of original packets each having original data and one or more forwarding properties specific to each original packet of the plurality of original packets;
forward the plurality of original packets on the path toward the original destination device;
generate a plurality of side packets with the side data, the plurality of side packets each having one or more forwarding properties specific to a corresponding original packet of the plurality of original packets; and
forward the plurality of side packets on the path toward the original destination device, the plurality of side packets intended for reception and processing of the side data by the side destination device that is on the path toward the destination device.

16. The apparatus as in claim 12, wherein the process when executed is further operable to:
set a time-to-live (TTL) counter within the side packet that is less than a number of hops to reach the original destination device and equal to or greater than a number of hops to reach the side destination device.

17. The apparatus as in claim 12, wherein the side destination device is configured to return side data to the side source device, wherein the process when executed is further operable to:
receive a return original packet on the TCP connection from the original destination device to the original source device, the return original packet having return original data and one or more forwarding properties specific to the return original packet;
forward the return original packet on a return path toward the original source device;
receive a return side data packet with return side data different from the return original data, the return side packet having the same one or more forwarding properties specific to the return original packet;
process the return side data; and
drop the return side data packet.

18. The apparatus as in claim 12, wherein the process when executed is further operable to:
encrypt the side data.

19. A method, comprising:
receiving, at a side destination device in a computer network, an original packet on a transmission control protocol (TCP) connection from an original source device to an original destination device, the original packet having original data and one or more forwarding properties specific to the original packet;
forwarding the original packet from the side destination device on a path toward the original destination device;
receiving, at the side destination device, a side data packet with side data different from the original data, the side packet having the same one or more forwarding properties specific to the original packet;
processing, by the side destination device, the side data; and
dropping the side data packet by the side destination device.

20. The method as in claim 19, further comprising:
receiving, at the side destination device, a return original packet on the TCP connection from the original destination device to the original source device, the return original packet having return original data and one or more forwarding properties specific to the return original packet;
forwarding the return original packet from the side destination device on a return path toward the original source device;
generating, at the side destination device, a return side data packet with return side data different from the return original data, the return side packet having the same one or more forwarding properties specific to the return original packet; and
forwarding the return side packet from the side destination device on the return path toward the original source device, the return side packet intended for reception and processing of the return side data by the side source device that is on the path toward the original source device.
